(19) United States
(12) Patent Application Publication
(10) Pub. No.: US 2012/0274213 A1
(43) Pub. Date: Nov. 1, 2012

(54) DRIVING APPARATUS FOR FLUORESCENT TUBES AND METHOD THEREOF

(75) Inventors: Chiu-Yuan Lin, Taipei City (TW); Chien-Pang Hung, Taipei City (TW); Chen-Lung Kao, Taipei City (TW)

(73) Assignee: BEYOND INNOVATION TECHNOLOGY CO., LTD., Taipei City (TW)

(21) Appl. No.: 13/353,284

(22) Filed: Jan. 18, 2012

(30) Foreign Application Priority Data
Apr. 28, 2011 (TW) 100114928

(51) Int. Cl. H05B 41/16; H05B 41/14

(52) U.S. Cl. 315/97; 315/283; 315/201; 315/246

(57) ABSTRACT

A driving apparatus for fluorescent tubes and a method thereof are provided. The provided driving apparatus changes a sinusoidal driving signal used for driving a fluorescent tube by detecting a current flowing through the fluorescent tube. Accordingly, the current flowing through the fluorescent tube can be conformed to specifications/regulations. Under the condition of being capable of detecting current(s) flowing through fluorescent tube(s), the provided driving apparatus can be suitable for driving fluorescent tubes with different specifications, categories and brands, and would not affect the lifetime of the fluorescent tubes and would not cause the problem of insufficient luminance.

### CROSS-REFERENCE TO RELATED APPLICATION

This application claims the priority benefit of Taiwan application serial no. 100114928, filed on Apr. 28, 2011. The entirety of the above-mentioned patent application is hereby incorporated by reference herein and made a part of this specification.

### TECHNICAL FIELD

The disclosure relates to a driving technique for fluorescent tubes, and more particularly, to a driving apparatus for hot-cathode fluorescent tubes and a method thereof.

### BACKGROUND

The fluorescent tubes are mainly selected to be used as lighting apparatuses used in the current life, in which straight long type (hot-cathode) fluorescent tubes are mostly used, and fluorescent tubes with different tube diameters such as T3, T5, T8, and T9 in terms of specifications. However, the fluorescent tubes with the specifications T3, T5, T8, and T9 have the same light emitting principle, in which a tube current causes mercury vapour to excite fluorescent coating on an inner wall of the tube to emit light.

Generally, in most cases, a driving apparatus (that is, a ballast) for existing fluorescent tubes provides a sinusoidal driving signal (also called an alternating current (AC) driving signal) with fixed energy to drive the fluorescent tube. However, the fluorescent tubes manufactured by different factories have different characteristics (that is, maximum currents flowing through the fluorescent tubes). Therefore, under the driving of the sinusoidal driving signal with the fixed energy, if the current flowing through the fluorescent tube is excessively high, the service lifetime of the fluorescent tube may be affected. On the contrary, the luminance provided by the fluorescent tube is insufficient.

In view of the above, recently, the driving apparatus (that is, the ballast) for existing fluorescent tubes may limit specifications, categories, and brands of the fluorescent tubes that can be matched. In other words, in most cases, in the design of the driving apparatus (that is, the ballast) for existing fluorescent tubes, the parameters are adjusted according to the specifications, categories, and brands of the fluorescent tubes to be matched, so as to enable the current flowing through the fluorescent tube to be conformed to specifications/regulations.

Apparently, recently no driving apparatus (that is, the ballast) for a single fluorescent tube can be suitable for driving the fluorescent tubes with the different specifications, categories, and brands.

### SUMMARY

A driving apparatus for fluorescent tubes and a method thereof are introduced herein, which are suitable for driving the fluorescent tubes with the different specifications, categories, and brands.

The disclosure provides a driving apparatus for fluorescent tubes, which includes a driving unit, a first LC resonator, and a first detection unit. The driving unit is operated under a direct current (DC) power, and used for generating a square signal. The first LC resonator is coupled to the driving unit, and used for receiving and converting the square signal generated by the driving unit, so as to generate a first sinusoidal driving signal to drive a first fluorescent tube. The first detection unit is coupled to the first fluorescent tube, and used for detecting a current flowing through the first fluorescent tube, and accordingly providing a first detection signal. The driving unit further adjusts the generated square signal in response to the first detection signal provided by the first detection unit, so as to change the first sinusoidal driving signal generated by the first LC resonator.

In an embodiment of the disclosure, the driving apparatus for the fluorescent tubes further includes a second LC resonator and a second detection unit. The second LC resonator is coupled to the driving unit, and used for receiving and converting the square signal generated by the driving unit, so as to generate a second sinusoidal driving signal to drive a second fluorescent tube. The second detection unit is coupled to the second fluorescent tube, and used for detecting a current flowing through the second fluorescent tube, and accordingly providing a second detection signal. The driving unit further adjusts the generated square signal in response to either of the first detection signal and the second detection signal respectively provided by the first detection unit and the second detection unit, so as to change the first sinusoidal driving signal and the second sinusoidal driving signal respectively generated by the first LC resonator and the second LC resonator.

In an embodiment of the disclosure, the first fluorescent tube and the second fluorescent tube at least are hot-cathode fluorescent tubes of T3, T5, T8, or T9.

The disclosure further provides a driving method for fluorescent tubes, which includes: providing and converting a square signal, so as to generate a sinusoidal driving signal to drive a fluorescent tube; and detecting a current flowing through the fluorescent tube, so as to adjust the square signal, thereby changing the sinusoidal driving signal.

In an embodiment of the disclosure, the energy of the sinusoidal driving signal for driving the fluorescent tube is not a fixed value.

Based on the above, the driving apparatus for fluorescent tubes according to the disclosure changes the sinusoidal driving signal used for driving the fluorescent tube by detecting the current flowing through the fluorescent tube. Accordingly, the current flowing through the fluorescent tube can be conformed to specifications/regulations. Under the condition of being capable of detecting current(s) flowing through fluorescent tube(s), the driving apparatus for fluorescent tubes according to the disclosure can be suitable for driving the fluorescent tubes with the different specifications, categories, and brands, and would not affect the lifetime of the fluorescent tubes and would not cause the problem of insufficient luminance.

It should be understood that the above description and the following detailed description of embodiments are exemplary and illustrative instead of limiting the scope of the disclosure.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic view of a driving apparatus for fluorescent tubes 10 according to an embodiment of the disclosure.

FIG. 2 is a schematic view of a driving apparatus for fluorescent tubes 20 according to another embodiment of the disclosure.

FIG. 3 is a flow chart of a driving method for fluorescent tubes according to an embodiment of the disclosure.

### DETAILED DESCRIPTION OF DISCLOSED EMBODIMENTS

Reference will now be made in detail to the present embodiments of the invention, examples of which are illustrated in the accompanying drawings. Wherever possible, the same reference numbers are used in the drawings and the description to refer to the same or like parts.

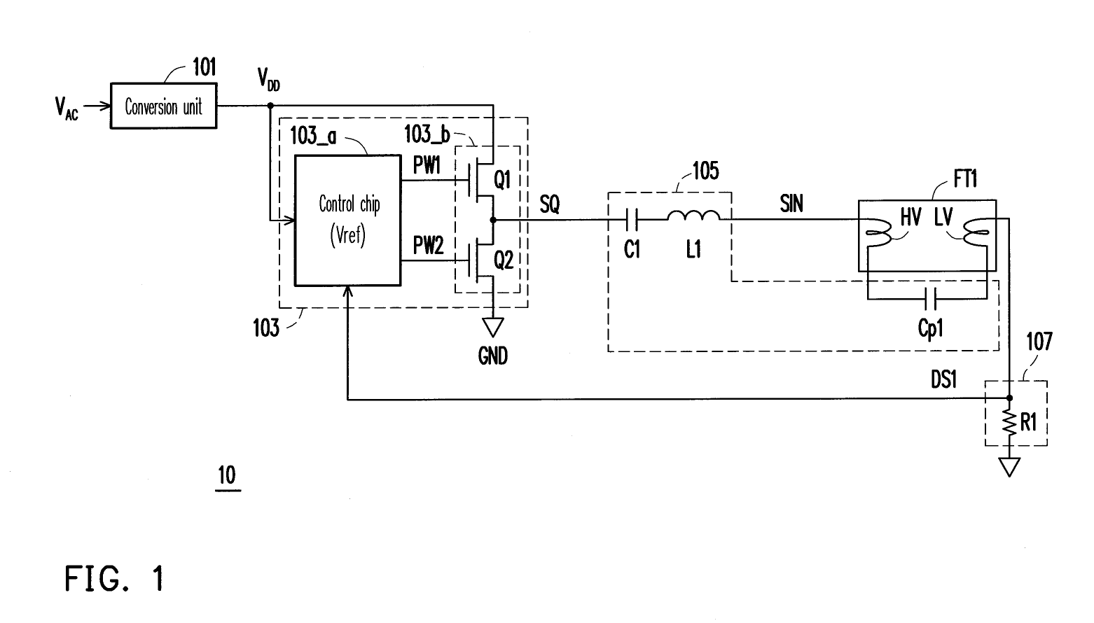

FIG. 1 is a schematic view of a driving apparatus for fluorescent tubes 10 according to an embodiment of the disclosure. Referring to FIG. 1, the driving apparatus for fluorescent tubes 10 includes a conversion unit 101, a driving unit 103, an LC resonator 105, and a detection unit 107. The conversion unit 101 is used for receiving an AC power V_{AC}, and converting the AC power V_{AC} to provide a DC power V_{DD}. Apparently, the conversion unit 101 may be an AC-to-DC converter.

The driving unit 103 is coupled to the conversion unit 101, and is operated under the DC power V_{DD} provided by the conversion unit 101 to generate a square signal SQ. The LC resonator 105 is coupled to the driving unit 103, and used for receiving and converting the square signal SQ generated by the driving unit 103, so as to generate a sinusoidal driving signal to drive a fluorescent tube FT1 (for example, a hot-cathode fluorescent tube of T3, T5, T8, T9, or other specifications).

The detection unit 107 is coupled to the fluorescent tube FT1, and used for detecting a current flowing through the fluorescent tube FT1, and accordingly providing a detection signal DS1. Also, the driving unit 103 further adjusts the generated square signal SQ in response to the detection signal DS1 provided by the detection unit 107, so as to change the sinusoidal driving signal SIN generated by the LC resonator 105.

In this embodiment, the driving unit 103 includes a control chip 103_{—}a and a switching circuit 103_{—}b. The control chip 103_{—}a is operated under the DC power V_{DD} provided by the conversion unit 101, and used for generating control signals PW1 and PW2 (for example, pulse width modulation (PWM) signals), and adjusting the control signals PW1 and PW2 (for example, adjusting duty cycles of the control signals PW1 and PW2) in response to the detection signal DS1 provided by the detection unit 107.

The switching circuit 103_{—}b is coupled between the DC power V_{DD} and a ground potential GND, and coupled to the control chip 103_{—}a. The switching circuit 103_{—}b is used for switching and outputting the DC power V_{DD} and the ground potential GND in response to the control signals PW1 and PW2 generated by the control chip 103_{—}a, so as to generate the square signal SQ. In this embodiment, the switching circuit 103_{—}b includes two power switches Q1 and Q2 (for example, implemented by N-type transistors). A first end of the power switch Q1 is coupled to the DC power V_{DD}, a second end of the power switch Q1 is used for outputting the square signal SQ, and a control end of the power switch Q1 is used for receiving the control signal PW1. In addition, a first end of the power switch Q2 is coupled to the ground potential GND, a second end of the power switch Q2 is coupled to the second end of the power switch Q1, and a control end of the power switch Q2 is used for receiving the control signal PW2.

The LC resonator 105 includes a capacitor C1, an inductor L1, and a capacitor Cp1. A first end of the capacitor C1 is used for receiving the square signal SQ generated by the driving unit 103. A first end of the inductor L1 is coupled to a second end of the capacitor C1, and a second end of the inductor L1 is coupled to a first end of a high side filament HV of the fluorescent tube FT1 to output the sinusoidal driving signal SIN. In addition, a first end of the capacitor Cp1 is coupled to a second end of the high side filament HV of the fluorescent tube FT1, and a second end of the capacitor Cp1 is coupled to a first end of a low side filament LV of the fluorescent tube FT1.

The detection unit 107 includes a resistor R1. A first end of the resistor R1 is coupled to a second end of the low side filament LV of the fluorescent tube FT1 to generate the detection signal DS1 to the control chip 103_{—}a, and a second end of the resistor R1 is coupled to the ground potential GND.

Based on the above, during the period of initially driving the fluorescent tube FT1, the control chip 103_{—}a may have a built-in preset value Vref relevant to a maximum current of the fluorescent tube FT1. Therefore, the control chip 103_{—}a may generate the control signals PW1 and PW2 relevant to the preset value Vref to switch the power switches Q1 and Q2, so as to generate the square signal SQ relevant to the preset value Vref. Next, the LC resonator 105 coverts the square signal SQ relevant to the preset value Vref, and accordingly generates the sinusoidal driving signal SIN to drive the fluorescent tube FT1. Further, during a transient process before the activation of the fluorescent tube FT1 is finished, the capacitor Cp1 provides a sufficiently high activation voltage, and provides a suitable filament current during stable operation of the fluorescent tube FT1.

In another aspect, during the period of stably driving the fluorescent tube FT1, the detection unit 107 may continuously provide the detection signal DS1 relevant to the current flowing through the fluorescent tube FT1 to the control chip 103_{—}a. Once the detection signal DS1 is higher than the preset value Vref, it represents that the current flowing through the fluorescent tube FT1 is excessively high. Accordingly, the control chip 103_{—}a adjusts the generated control signals PW1 and PW2 (for example, lowers the duty cycles of the control signals PW1 and PW2), so as to lower the energy of the sinusoidal driving signal SIN for driving the fluorescent tube FT1, until the detection signal DS1 is lower than the preset value Vref. Apparently, in this embodiment, the energy of the sinusoidal driving signal SIN for driving the fluorescent tube FT1 is not a fixed value, and changes in response to the excessively high current flowing through the fluorescent tube FT1, so that the current flowing through the fluorescent tube FT1 is always conformed to specifications/regulations.

It should be noted that in this embodiment the example for illustration is that a single fluorescent tube is driven, but the disclosure is not limited thereto. In the following, an embodiment, in which a plurality of fluorescent tubes is driven, is given.

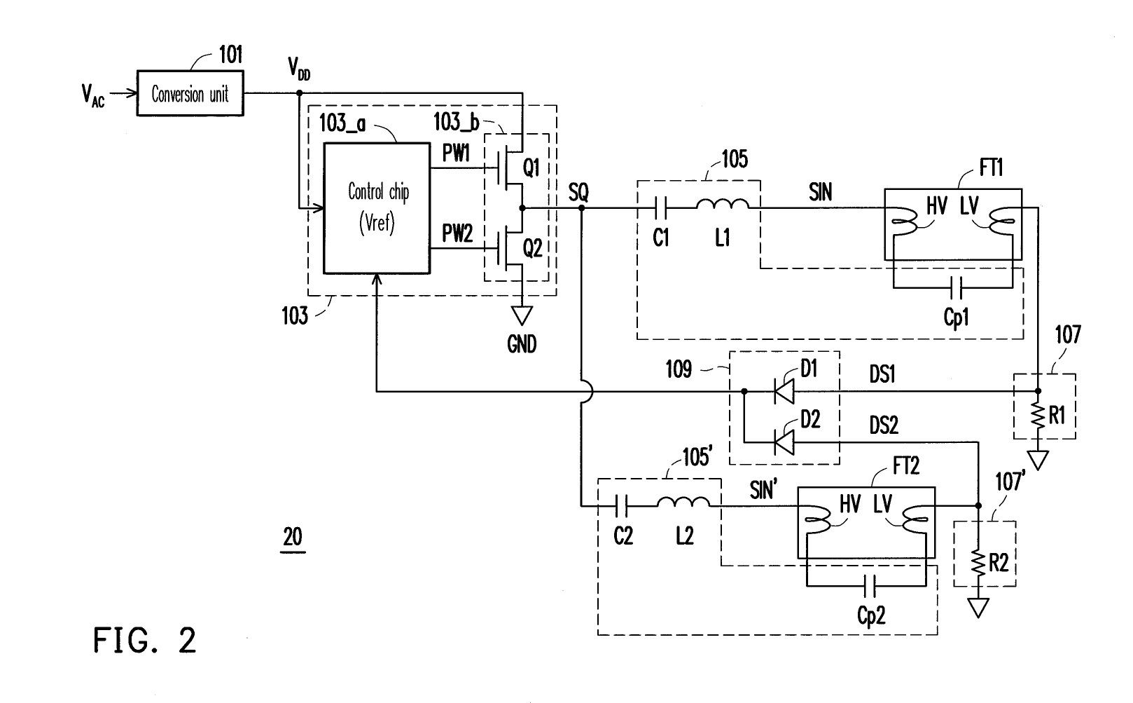

FIG. 2 is a schematic view of a driving apparatus for fluorescent tubes 20 according to another embodiment of the disclosure. Referring to FIGS. 1 and 2, the difference between the driving apparatus for fluorescent tubes 20 and the driving apparatus for fluorescent tubes 10 is that the driving apparatus for fluorescent tubes 20 further includes an LC resonator 105′, a detection unit 107′, and a selection circuit 109.

Similarly, the LC resonator 105′ is coupled to the driving unit 103, and used for receiving and converting the square signal SQ generated by the driving unit 103, so as to generate a sinusoidal driving signal SIN′ to drive a fluorescent tube FT2 (for example, a hot-cathode fluorescent tube of T3, T5, T8, T9, or other specifications). In addition, the detection unit 107′ is coupled to the fluorescent tube FT2, used for detecting a current flowing through the fluorescent tube FT2, and accordingly providing a detection signal DS2. Further, the selection circuit 109 is coupled to a control chip 103_{—}a and the detection units 107 and 107′, and used for receiving the detection signals DS1 and DS2 respectively provided by the detection units 107 and 107′, and selecting one of the detection signals DS1 and DS2 for the driving unit 103.

In this manner, the driving unit 103 adjusts the generated square signal SQ in response to either of the detection signals DS1 and DS2 respectively provided by the detection units 107 and 107′, so as to change the sinusoidal driving signals SIN and SIN′ respectively generated by the LC resonators 105 and 105′. Adjustment of the square signal SQ and adjustment of the sinusoidal driving signals SIN and SIN′ are based on that the control chip 103_{—}a adjusts the controls signals PW1 and PW2 in response to either of the detection signals DS1 and DS2 respectively provided by the detection units 107 and 107′ (for example, adjusts the duty cycles of the control signals PW1 and PW2).

In another aspect, the LC resonator 105′ includes a capacitor C2, an inductor L2, and a capacitor Cp2. A first end of the capacitor C2 is used for receiving the square signal SQ generated by the driving unit 103. A first end of the inductor L2 is coupled to a second end of the capacitor C2, and a second end of the inductor L2 is coupled to a first end of a high side filament HV of the fluorescent tube FT2 to output the sinusoidal driving signal SIN′. In addition, a first end of the capacitor Cp2 is coupled to a second end of the high side filament HV of the fluorescent tube FT2, and a second end of the capacitor Cp2 is coupled to a first end of a low side filament LV of the fluorescent tube FT2.

In addition, the detection unit 107′ may include a resistor R2. A first end of the resistor R2 is coupled to a second end of the low side filament LV of the fluorescent tube FT2 to generate a detection signal DS2 to the selection circuit 109, and a second end of the resistor R2 is coupled to the ground potential GND. Meanwhile, the detection unit 107 may also generate the detection signal DS1 to the selection circuit 109.

Further, the selection circuit 109 may include diodes D1 and D2. An anode of the diode D1 is used for receiving the detection signal DS1 provided by the detection unit 107, and a cathode of the diode D1 is coupled to the control chip 103_{—}a. An anode of the diode D2 is used for receiving the detection signal DS2 provided by the detection unit 107′, and a cathode of the diode D2 is coupled to the cathode of the diode D1.

Based on the above, during the period of initially driving the fluorescent tubes FT1 and FT2, the control chip 103_{—}a has a built-in preset value Vref relevant to a maximum current of the fluorescent tube FT1 or FT2 with a relatively low wattage. Therefore, the control chip 103_{—}a may generate the control signals PW1 and PW2 relevant to the preset value Vref to switch the power switches Q1 and Q2, so as to generate the square signal SQ relevant to the preset value Vref. Next, the LC resonators 105 and 105′ convert the square signal SQ relevant to the preset value Vref, and accordingly generate the sinusoidal driving signals SIN and SIN′ to respectively drive the fluorescent tubes FT1 and FT2. Similarly, during a transient process before the activation of the fluorescent tube FT2 is finished, the capacitor Cp2 provides a sufficiently high activation voltage, and provides a suitable filament current during stable operation of the fluorescent tube FT2.

In another aspect, during the period of stably driving the fluorescent tubes FT1 and FT2, the detection units 107 and 107′ may continuously provide the detection signals DS1 and DS2 respectively relevant to the currents flowing through the fluorescent tubes FT1 and FT2 to the selection circuit 109. Further, the selection circuit 109 selects either of the detection signals DS1 and DS2 which has the greater voltage for the control chip 103_{—}a. Once the output of the selection circuit 109 is higher than the preset value Vref, it represents that the current flowing through the fluorescent tube FT1 or FT2 with the relatively low wattage is excessively high.

Moreover, the control chip 103_{—}a adjusts the generated control signals PW1 and PW2 (for example, lowers the duty cycles of the control signals PW1 and PW2), so as to simultaneously lower the energy of the sinusoidal driving signals SIN and SIN′ for driving the fluorescent tubes FT1 and FT2, until the output of the selection circuit 109 is lower than the preset value Vref. Similarly, in this embodiment, the energy of the sinusoidal driving signals SIN and SIN′ for driving the fluorescent tubes FT1 and FT2 is not a fixed value, and changes in response to the excessively high current flowing through the fluorescent tube FT1 or FT2 with the relatively low wattage, so that the currents flowing through the fluorescent tubes FT1 and FT2 are always conformed to specifications/regulations.

It should be known that even the specifications, categories, and brands of the fluorescent tubes FT1 and FT2 are different, and the driving apparatus for fluorescent tubes 20 may still drive the fluorescent tubes FT1 and FT2 without affecting the lifetime of the fluorescent tube or generating the insufficient luminance. Accordingly, if it is designed that the driving apparatus for fluorescent tubes 20 has a single ballast, the single ballast may be suitable for driving the fluorescent tubes with the different specifications, categories, and brands. Moreover, no matter during the period of initially driving the fluorescent tube or during the period of stably driving the fluorescent tube, the current flowing through the fluorescent tube is always controlled at a stable numerical value. Therefore, the luminance when the fluorescent tube is initially lighted and the luminance after the fluorescent tube is stably lighted do not have much differences.

In addition, the embodiment clearly discloses and teaches how to drive two fluorescent tubes without affecting the lifetime of the fluorescent tube or generating the insufficient luminance. Therefore, persons of ordinary skill in the field may infer or deduce how to drive more than two fluorescent tubes without affecting the lifetime of the fluorescent tube or generating the insufficient luminance based on such teaching contents, so the description is omitted here.

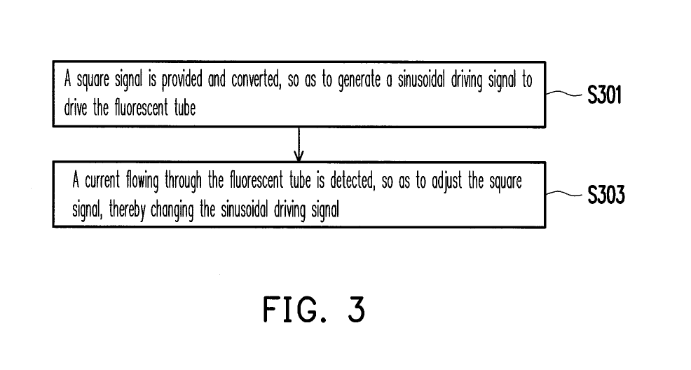

Here, based on the contents disclosed and taught by the above embodiment, a universal driving method for the (hot-cathode) fluorescent tubes may be known. More clearly, FIG. 3 is a flow chart of a driving method for fluorescent tubes according to an embodiment of the disclosure. Referring to FIG. 3, the driving method for fluorescent tubes according to this embodiment includes the following steps.

A square signal is provided and converted, so as to generate a sinusoidal driving signal to drive the fluorescent tube (Step S301).

A current flowing through the fluorescent tube is detected, so as to adjust the square signal, thereby changing the sinusoidal driving signal (Step S303).

In this embodiment, the energy of the sinusoidal driving signal for driving the fluorescent tube is not a fixed value, and changes in response to the excessively high current flowing through the fluorescent tube.

To sum up, the driving apparatus for fluorescent tubes according to the disclosure changes the sinusoidal driving signal used for driving the fluorescent tube by detecting the current flowing through the fluorescent tube. Accordingly, the current flowing through the fluorescent tube can be conformed to specifications/regulations. Under the condition of being capable of detecting current(s) flowing through fluorescent tube(s), the driving apparatus for fluorescent tubes according to the disclosure can be suitable for driving the fluorescent tubes with the different specifications, categories, and brands, and would not affect the lifetime of the fluorescent tubes and would not cause the problem of insufficient luminance.

It will be apparent to those skilled in the art that various modifications and variations can be made to the structure of the disclosure without departing from the scope or spirit of the invention. In view of the foregoing, it is intended that the disclosure cover modifications and variations of this invention provided they fall within the scope of the following claims and their equivalents.

What is claimed is:

1. A driving apparatus for fluorescent tubes, comprising:
a driving unit, operated under a direct current (DC) power, and used for generating a square signal;
a first LC resonator, coupled to the driving unit, and used for receiving and converting the square signal, so as to generate a first sinusoidal driving signal to drive a first fluorescent tube; and
a first detection unit, coupled to the first fluorescent tube, used for detecting a current flowing through the first fluorescent tube, and accordingly providing a first detection signal,
wherein the driving unit further adjusts the square signal in response to the first detection signal, so as to change the first sinusoidal driving signal.

2. The driving apparatus for fluorescent tubes according to claim 1, wherein the driving unit comprises:
a control chip, operated under the DC power, used for generating a first control signal and a second control signal, and adjusting the first control signal and the second control signal in response to the first detection signal; and
a switching circuit, coupled between the DC power and a ground potential and coupled to the control chip, used for switching and outputting the DC power and the ground potential in response to the first control signal and the second control signal, so as to generate the square signal.

3. The driving apparatus for fluorescent tubes according to claim 2, wherein the switching circuit comprises:
a first power switch, having a first end coupled to the DC power, a second end used for outputting the square signal, and a control end used for receiving the first control signal; and
a second power switch, having a first end coupled to the ground potential, a second end coupled to the second end of the first power switch, and a control end used for receiving the second control signal.

4. The driving apparatus for fluorescent tubes according to claim 3, wherein the first LC resonator comprises:
a first capacitor, having a first end used for receiving the square signal;
an inductor, having a first end coupled to a second end of the first capacitor, a second end coupled to a first end of a high side filament of the first fluorescent tube to output the first sinusoidal driving signal; and
a second capacitor, having a first end coupled to a second end of the high side filament, and a second end coupled to a first end of a low side filament of the first fluorescent tube.

5. The driving apparatus for fluorescent tubes according to claim 4, wherein the first detection unit comprises:
a resistor, having a first end coupled to a second end of the low side filament to generate the first detection signal to the control chip, and a second end coupled to the ground potential.

6. The driving apparatus for fluorescent tubes according to claim 1, further comprising:
a second LC resonator, coupled to the driving unit, and used for receiving and converting the square signal, so as to generate a second sinusoidal driving signal to drive a second fluorescent tube; and
a second detection unit, coupled to the second fluorescent tube, and used for detecting a current flowing through the second fluorescent tube, and accordingly providing a second detection signal,
wherein the driving unit further adjusts the square signal in response to either of the first detection signal and the second detection signal, so as to change the first sinusoidal driving signal and the second sinusoidal driving signal.

7. The driving apparatus for fluorescent tubes according to claim 6, wherein the driving unit comprises:
a control chip, operated under the DC power, and used for generating a first control signal and a second control signal, and adjusting the first control signal and the second control signal in response to either of the first detection signal and the second detection signal; and
a switching circuit, coupled between the DC power and a ground potential, coupled to the control chip, and used for switching and outputting the DC power and the ground potential in response to the first control signal and the second control signal, so as to generate the square signal.

8. The driving apparatus for fluorescent tubes according to claim 7, wherein the switching circuit comprises:
a first power switch, having a first end coupled to the DC power, a second end used for outputting the square signal, and a control end used for receiving the first control signal; and
a second power switch, having a first end coupled to the ground potential, a second end coupled to the second end of the first power switch, and a control end used for receiving the second control signal.

9. The driving apparatus for fluorescent tubes according to claim 8, wherein the first LC resonator comprises:
a first capacitor, having a first end used for receiving the square signal;
an inductor, having a first end coupled to a second end of the first capacitor, a second end coupled to a first end of a high side filament of the first fluorescent tube to output the first sinusoidal driving signal; and
a second capacitor, having a first end coupled to a second end of the high side filament, and a second end coupled to a first end of a low side filament of the first fluorescent tube.

10. The driving apparatus for fluorescent tubes according to claim 9, wherein the first detection unit comprises:
a resistor, having a first end coupled to a second end of the low side filament to generate the first detection signal, and a second end coupled to the ground potential.

11. The driving apparatus for fluorescent tubes according to claim 8, wherein the second LC resonator comprises:
a first capacitor, having a first end used for receiving the square signal;
an inductor, having a first end coupled to a second end of the first capacitor, and a second end coupled to a first end of a high side filament of the second fluorescent tube to output the second sinusoidal driving signal; and
a second capacitor, having a first end coupled to a second end of the high side filament, and a second end coupled to a first end of a low side filament of the second fluorescent tube.

12. The driving apparatus for fluorescent tubes according to claim 11, wherein the second detection unit comprises:
a resistor, having a first end coupled to a second end of the low side filament to generate the second detection signal, and a second end coupled to the ground potential.

13. The driving apparatus for fluorescent tubes according to claim 7, further comprising:
a selection circuit, coupled to the first detection unit, the second detection unit, and the control chip, and used for receiving the first detection signal and the second detection signal, and selecting either of the first detection signal and the second detection signal for the control chip.

14. The driving apparatus for fluorescent tubes according to claim 13, wherein the selection circuit comprises:
a first diode, having an anode used for receiving the first detection signal, and a cathode coupled to the control chip; and
a second diode, having an anode used for receiving the second detection signal, and a cathode coupled to the cathode of the first diode.

15. The driving apparatus for fluorescent tubes according to claim 6, wherein the first fluorescent tube and the second fluorescent tube at least are hot-cathode fluorescent tubes of T3, T5, T8, or T9.

16. The driving apparatus for fluorescent tubes according to claim 1, further comprising:
a conversion unit, coupled to the driving unit, and used for receiving an alternating current (AC) power, and converting the AC power to provide the DC power.

17. A driving method for fluorescent tubes, comprising:
providing and converting a square signal, so as to generate a sinusoidal driving signal to drive the fluorescent tube; and
detecting a current flowing through the fluorescent tube, so as to adjust the square signal, thereby changing the sinusoidal driving signal.

18. The driving method for fluorescent tubes according to claim 17, wherein energy of the sinusoidal driving signal for driving the fluorescent tube is not a fixed value.
